(19) United States
(12) Patent Application Publication
(10) Pub. No.: US 2012/0045584 A1
(43) Pub. Date: Feb. 23, 2012

(54) FIRE RESISTANT TIMBER COATING COMPOSITIONS AND METHODS OF MANUFACTURE

(75) Inventors: Richard DETTBARN, Calgary (CA); Joseph GARRIDO, Oakville (CA)

(73) Assignee: CANO COATINGS INC., Calgary (CA)

(21) Appl. No.: 12/943,746

(22) Filed: Nov. 10, 2010

Related U.S. Application Data
(60) Provisional application No. 61/374,360, filed on Aug. 17, 2010.

(51) Int. Cl. C08K 3/32; B05D 3/02

(52) U.S. Cl. 427/368; 524/417; 427/393

(57) ABSTRACT

This application relates to compositions and methods for coating timber and the like to increase the fire resistant properties of the timber. Specifically, the compositions include water, acrylic resin, aluminum trihydrate and ammonium polyphosphate that can be used to effectively coat lumber products and impart fire-resistant properties to the lumber products. In addition, the compositions can include an anti-microbial agent to increase the anti-microbial properties of the coated timber products. The compositions can also include a coloring agent in order that coated lumber products have a recognizable tint indicating to users that the lumber products have been treated with the compositions to increase the fire-resistance and anti-microbial properties of the lumber.

### CROSS REFERENCE TO RELATED APPLICATIONS

This application claims the benefit of U.S. Provisional Application Ser. No. 61/374,360, filed Aug. 17, 2010, entitled “Mold Resistant Timber Coating Compositions and Methods of Manufacture”, and Canadian Patent Application No. “______” filed Oct. 28, 2010, entitled “Fire Resistant Timber Coating Compositions and Methods of Manufacture”, the entire disclosures of which are incorporated herein by reference.

### FIELD OF THE INVENTION

This application relates to compositions and methods for coating timber and the like to increase the fire resistant properties of the timber. Specifically, the compositions include water, acrylic resin, aluminum trihydrate and ammonium polyphosphate that can be used to effectively coat lumber products and impart fire-resistant properties to the lumber products. In addition, the compositions can have an anti-microbial agent to increase the anti-microbial properties of the coated timber. The compositions can also include a coloring agent in order that coated lumber products have a recognizable tint indicating to users that the lumber products have been treated with the fire-resistant and anti-microbial composition.

### BACKGROUND OF THE INVENTION

By way of background, fungi growth, such as mold (also referred to as mildew), rot and insect infestation in buildings in various climates is an ongoing issue. Mold spores are constantly present in the air, and if the mold spores land on a wet or damp surface under the right conditions, the mold spores will multiply. This is a concern to many people as molds have the potential to cause health problems due to the production of allergens, irritants, and in some cases, potentially toxic substances (mycotoxins) by molds.

In addition to health problems, mold growth has the potential to cause physical and structural damage to buildings. Mold needs nutrients to survive and many common materials found in homes such as wood, paper and organic fibers can provide the necessary nutrients for mold. Consequently, mold may cause physical and structural damage to a building as the mold consumes the building materials for nutrients.

Due to potential mold issues in old and new buildings alike, many homebuyers, real estate professionals and mortgage companies are beginning to request home inspections and mold inspections. There is a growing tendency for homeowners and building owners to pursue legal action against contractors and other parties when mold is discovered. As such, there is a need within the construction industry for improved methods and materials to prevent and/or remediate mold growth as well as decrease the susceptibility of building materials to rot, insect infestation and water absorption.

Furthermore, various jurisdictions are interested in ensuring that the fire-resistance of newly constructed buildings is improved at the time of construction. Importantly, by improving the fire-resistance of a building, not only can the risk of starting a fire within the building be diminished but also, in the event that a fire is started, the speed of propagation of the fire may also be diminished. Reducing the speed of propagation of a fire within a building can dramatically improve the time-window for occupants to be alerted to and escape the fire as well improve the amount of time for fire-fighters and other emergency personnel to respond to, and effectively intervene to extinguish the fire and/or rescue occupants. These factors are therefore very important in improving overall fire safety within the community as well as contributing to other benefits to building-owners including reduced fire-insurance rates.

In response to these considerations, jurisdictions have implemented changes to fire codes in order to address the above. For example, the Alberta Building code in Canada has recently been amended to minimize the severity, frequency and damage caused to buildings by fire, and to improve the security and safety for construction workers and occupants of buildings.

More specifically, and as is known, the majority of new homes in North America are constructed using frame construction in which standard dimension lumber is used to create a frame of the building that is subsequently used to support other components of the building including roofing, windows, insulation, interior and exterior sheathing etc. Jurisdictional building codes typically require that framing lumber has been dried to a specified moisture content according to various engineering standards and protocols so as to minimize or reduce subsequent warping or twisting of the lumber as it dries out over time. As a result of the drying processes that such lumber is subjected to, the lumber frame of a typical building is highly combustible such that in the event that a fire is initiated, the relative dryness of the lumber contributes to the rapid combustion and propagation of a fire.

Fire-retardant coatings on lumber or the use of other retardant materials can be effective in minimizing the combustibility of lumber and have been used in the past in a large number of applications to effectively minimize or reduce the combustibility of lumber or otherwise impart other properties to the lumber. While past compositions have been effective, there continues to be a need for improved compositions that are effective in reducing the combustibility of the lumber, are non-toxic and have low environmental impact, and can be easily and cost-effectively applied to lumber so as to not significantly affect the cost of the lumber materials and thus the overall cost of the new building.

Mold-inhibiting and fire-inhibiting compositions for coating building materials are known in the prior art. U.S. Pat. No. 7,482,395 discloses an intumescent fire retardant paint containing a mold inhibitor and having a latex base that is intended to cover interior paper or paper-coated wallboard products. Further compositions for application to wood products to protect the wood products from fire, wood destroying organisms and fungi are taught in U.S. Patent Application No. 2006/0257578; U.S. Pat. No. 6,620,349; U.S. Pat. No. 7,547,354; U.S. Pat. No. 7,470,313; U.S. Pat. No. 6,517,748; and U.S. Pat. No. 6,881,247. These compositions include various boron source compounds, which are known in the art as having protective properties against fungal decay and insect-caused decay, as well as having fire-retardant properties when incorporated into cellulose materials.

U.S. Pat. No. 5,151,127 teaches fire retardation and wood preservation compositions having inorganic salts encapsulated by a water-based acrylic resin solution. Such a composition must be mixed in a specific way in order to avoid coagulation of the mixture.

Importantly, there is a need for cost effective compositions for coating wood products that protects the wood products from fungal decay and insect decay as well as increases the water-resistant and fire-resistant properties of the wood. Ideally, such a composition is easily manufactured and can be applied to lumber in a single step after the lumber has been otherwise dressed and cut for packaging and delivery to a worksite or at the worksite.

### SUMMARY OF THE INVENTION

In accordance with the invention, there is provided compositions and methods for coating timber and the like to increase the fire resistant properties of the timber.

More specifically, there is provided a fire-resistant composition for application to a wood substrate comprising: 65-85 wt % water; 3-18 wt % acrylic resin; 3-7 wt % aluminum trihydrate; and 3-7 wt % ammonium polyphosphate.

In another embodiment, the compositions may include up to 7 wt % of any one of or a combination of antisettling agents, defoamers, biocides, solvents, thickeners, surfactants, dispersants and clays.

In a further embodiment, the compositions may include less than 4 wt % anti-microbial agent.

In one embodiment, the composition will also include at least one coloring agent and in a more specific embodiment, a pink coloring agent in a sufficient concentration to impart a pink coloration to a wood substrate treated with the composition.

In another embodiment, the concentration of alumina trihydrate and ammonium polyphosphate is sufficient to impart fire-resistant properties to a wood substrate treated with the composition.

In a more specific embodiment, the invention provides a fire-resistant composition for application to a wood substrate comprising: 75.8 wt % water; 7.8 wt % acrylic resin; 4.7 wt % aluminum trihydrate; 4.7 wt % ammonium polyphosphate; 2.8 wt % anti-settling agent; 1.6 wt % fungicide; 1.2 wt % thickener; 1.1 wt % white colorant; <0.1 wt % red colorant; <0.1 wt % defoamer; <0.1 wt % biocide; <0.1 wt % solvent; and, <0.1 wt % surfactant.

In another aspect of the invention, a method of treating a wood substrate to impart fire-resistance to the wood substrate is provided comprising the steps of:
a. coating a fire-resistant composition as described herein on a lumber substrate; and,
b. allowing the lumber substrate to dry.

The coating step may be any one of or a combination of spray, dip or brush coating.

In yet another aspect, the invention provides a method of preparing a fire-resistant composition for treating a wood substrate comprising the steps of:
a. mixing an anti-settling agent with water to form a uniform mixture;
b. mixing acrylic resin, aluminum trihydrate, and ammonium polyphosphate with the uniform mixture from step a) to form a second uniform mixture;
   wherein the final concentrations in the second uniform mixture are: 65-85 wt % water; 3-18 wt % acrylic resin; 3-7 wt % aluminum trihydrate; 3-7 wt % ammonium polyphosphate; and <2.8 wt % anti-settling agent.

### BRIEF DESCRIPTION OF THE DRAWINGS

The invention is described with reference to the drawings in which:

FIG. 1 are graphs showing flame spread, smoke and temperature vs. time curves for treated spruce in accordance with one embodiment of the invention;

FIG. 2 are graphs showing flame spread, smoke and temperature vs. time curves for treated plywood in accordance with one embodiment of the invention;

FIG. 3 are graphs showing flame spread, smoke and temperature vs. time curves for treated ⅝″ plywood for a first run in accordance with one embodiment of the invention;

FIG. 4 are graphs showing flame spread, smoke and temperature vs. time curves for treated ⅝″ plywood for a second run in accordance with one embodiment of the invention;

FIG. 5 are graphs showing flame spread, smoke and temperature vs. time curves for treated ⅝″ plywood for a third run in accordance with one embodiment of the invention;

FIG. 6 are graphs showing flame spread, smoke and temperature vs. time curves for treated spruce lumber for a first run in accordance with one embodiment of the invention;

FIG. 7 are graphs showing flame spread, smoke and temperature vs. time curves for treated spruce lumber for a second run in accordance with one embodiment of the invention; and

FIG. 8 are graphs showing flame spread, smoke and temperature vs. time curves for treated spruce lumber for a third run in accordance with one embodiment of the invention.

### DETAILED DESCRIPTION OF THE INVENTION

In accordance with the invention, compositions and methods of coating wood products with such compositions are described. The compositions described herein impart fire resistance properties to wood substrates and more specifically, can be used to improve the flame spread characteristics of a coated wood substrate.

### Compositions

In accordance with the invention, acrylic-based compositions are described comprising by weight 65-85% water, 3-18% acrylic resin, 3-7% alumina trihydrate (ATH) and 3-7% ammonium polyphosphate. In various embodiments, >0 and <4% anti-microbial agent may also be added to the composition to impart anti-microbial properties.

Small amounts of antisettling agents, defoaming agents, biocides (including fungicides), solvents, thickeners and surfactants may be included in the compositions to promote solution stability and/or anti-microbial properties as known to those skilled in the art. Coloring agents may also be included to provide the composition with a desired pigment.

### Acrylic Resin

The acrylic resin functionally provides texture to the composition and other base properties such as water-resistant properties and weatherproofing (sealing), hardness and support for pigments (if any). The acrylic resin may be selected from a variety of known water-based acrylic resins such as Acronal® (manufactured by BASF, Mississauga, ON, Canada), Rhoplex® (manufactured by Rohn and Haas, West Philadelphia, Pa., United States of America) or Carboset® (manufactured by Lubrizol, Wickliffe, Ohio, 44092, United States of America).

### Alumina Trihydrate and Ammonium Polyphosphate

Alumina Trihydroxide (Al(OH)₃) or Alumina Trihydrate (ATH) combined with ammonium polyphosphate provide fire resistant properties to the composition. Ammonium polyphosphate is a non-toxic flame-retardant substance.

Specifically, alumina trihydroxide/alumina trihydrate combined with ammonium polyphosphate cause a carbonaceous foam to form on the product coated with the composition upon exposure to flame, effectively providing fire resistance (as detailed in greater detail below) to the product.

In the preferred embodiment, approximately 4.7 wt % aluminum trihydrate and 4.7 wt % ammonium polyphosphate are added to the composition. A suitable ATH is Almatis SpaceRite® (manufactured by Almatis, Inc. of Leetsdale, Pa., 15056, United States of America). A suitable ammonium polyphosphate is Exolit AP® (manufactured by Clariant Corporation of Charlotte, N.C., 28205, United States of America). In the context of the invention, it is understood that variations in the precise formulations can be introduced while maintaining improved fire resistance properties as understood by those skilled in the art.

### Anti-Microbial Agent

A small amount (>0 and <4% by weight) of anti-microbial agent (e.g. a fungicide) is preferably added to the composition to increase the anti-microbial resistance of the final coated product. The anti-microbial agent decreases the susceptibility of decay in the final coated product by increasing resistance in the product to mold and mildew. It is preferable that the minimum amount of anti-microbial agent to be effective is added to the composition. In the preferred embodiment 1-2 wt % fungicide is used, with a suitable fungicide being Fungitrol® (manufactured by International Specialty Products of Mississauga, Ontario, Canada).

### Coloring Agents

Coloring Agents can be added to the composition to provide a distinctive color to coated substrates. For example, lumber that has been treated in accordance with methods of the invention can result in products with a recognized color tint (e.g. pink) that indicates to the users that the lumber has been treated. This can be highly effective at a job site to provide workers with the ability to readily recognize that lumber that may be required for a specific use or location in the building structure depending on building code requirements.

### Other Additives

As noted above, other additives may be introduced to the composition in order to impart various properties to the composition including solution stability, viscosity, wetability, etc. Additives such as known dispersants, defoaming agents, biocides, solvents, thickeners and/or surfactants may be added to impart such properties to the solution as known to those skilled in the art.

### Composition Properties

Various compositions prepared in accordance with the invention may be characterized by the properties as shown in Table 1.

TABLE 1
Composition Properties

| Property | Value |
|---|---|
| Density | 1.04-1.13 kg/L |
| Viscosity | Spray viscosity |
| Draw Down Appearance | Smooth and uniform |
| pH | 8.0-9.0 |
| Non-volatile component | 15-25% |
| PVC component | 55-70% |

### Methods of Manufacture

The compositions are preferably manufactured by adding an antisettling agent under agitation to water and mixing until a uniform composition is created. Subsequently, with low agitation, the remaining components, including the aluminum trihydrate, ammonium polyphosphate, acrylic resin, and any additives are mixed into the compositions until the compositions appear uniform once again.

### Methods of Application

The compositions may be applied to cut and dressed lumber by known methods such as spray-coating, dip-coating and/or by brush application.

Spray-coating may be performed using standard spraying equipment wherein dressed and cut lumber may be passed through a spray curtain to provide an even coat on the outer surfaces of the lumber. Appropriate air drying techniques can be used to ensure a consistent coat.

Dip coating may be performed by submerging an appropriate quantity of dressed and cut lumber into a tank containing the composition for an appropriate soak-time. After removal from the immersion tank, the lumber is allowed to dry.

In addition, the compositions may be brushed on a lumber substrate.

### Example

Table 2 shows a preferred embodiment of the composition.

TABLE 2
Example Composition

| | Concentration |
|---|---|
| Ingredient | (weight percent) |
| Water | 75.8 |
| Acrylic resin | 7.8 |
| Aluminum trihydrate | 4.7 |
| Ammonium polyphosphate | 4.7 |
| Anti-settling agent | 2.8 |
| Fungicide | 1.6 |
| Thickener | 1.2 |
| White Colorant | 1.1 |
| Red Colorant | <0.1 |
| Defoamer | <0.1 |
| Biocide | <0.1 |
| Solvent | <0.1 |
| Surfactant | <0.1 |

### Resistance to Mold Growth Testing

Lumber samples coated with the composition described in Table 2 underwent an ASTM D3273 (2000) test, specifically the Standard Test Method for the Resistance to Growth of Mold on the Surface of Interior Coatings in an Environmental Chamber at the Intertek microbiology lab in Columbus, Ohio, United States of America. Three samples of treated lumber and three samples of untreated lumber were tested for their ability to resist mold when exposed to Aspergillus niger, Penicillium citrinum, and Auerobasidium pullalans.

### Testing Protocol

The test lumber samples were sterilized with a surface disinfectant and then inoculated. Four days prior to testing the samples were brought to 23° C.+/−2° C. and 50%+/−5% relative humidity. Mold samples were prepared and put into a solution that was poured over soil and allowed to grow for two weeks. The test lumber samples were hung above the soil mixture for four weeks along with positive and negative control samples. After four weeks, a visual mold growth rating on a scale of 0-10 based on ASTM D3274 was taken, with 0 being complete coverage and 10 being no fungal growth.

TABLE 3
Resistance to Mold Growth Testing Results

| | A. pullulans | A. niger | P. citrinum |
|---|---|---|---|
| Sample | (rating) | (rating) | (rating) |
| Untreated wood sample | 0 | 0 | 0 |
| Untreated wood sample | 0 | 0 | 0 |
| Untreated wood sample | 0 | 0 | 0 |
| Treated wood sample | 10 | 9 | 10 |
| Treated wood sample | 10 | 10 | 10 |
| Treated wood sample | 10 | 9 | 9 |

As shown from the foregoing, the treated lumber showed a significant resistance to mold as compared to the untreated lumber. Importantly, the treated lumber did not change the ability to work with the lumber as the coatings effectively only provided a color change to the exterior of the lumber.

### Resistance to Fire Testing

### ASTM E84-10 Testing

Lumber samples coated with the composition described in Table 2 underwent an international standard ASTM E84-10 test, specifically the Standard Test Method for Surface Burning Characteristics of Materials at the Intertek Evaluation Center in Coquitlam, British Columbia, Canada. Samples of treated spruce and treated plywood were tested to evaluate their surface burning characteristics.

The tests were conducted in accordance with the standard methods of ASTM E84-10. For the first test, three 24 inch wide by 8 foot long panels of ⅜ inch thick plywood were placed on the upper ledge of a flame spread tunnel. A layer of 6 mm reinforced cement board was placed on top of the sample, the tunnel lid was lowered into place, and the samples were tested in accordance with ASTM E84-10. For the second test, the procedure was repeated using four 12 foot long by 12 inch wide treated spruce panels to form two 24 inch wide by 24 foot long samples.

The results of the ASTM E84-10 tests are expressed by indexes which compare the sample characteristics relative to that of select grade red oak flooring and asbestos-cement board. The two tests are the Flame Spread Classification Test and the Smoke Development Test. Red Oak is assigned a classification of 100 for both tests, while asbestos-cement board is assigned a classification of 0. Western spruce is also assigned a value of 100 whereas plywoods typically have values in the range of 90-140 depending on their thickness, primary woods, core materials and structure. For example, a ¾″ birch plywood with a high density veneer core would have a flame spread value of 114.

The Flame Spread Classification Test relates to the rate of progression of a flame along the lumber sample in the 25 foot testing tunnel. A natural gas flame is applied to the front of the sample and drawn along the sample by a constant draft for the duration of the test. An observer notes the progression of the flame front relative to time and the information is plotted on a graph to form a flame spread curve. The test apparatus is calibrated such that the flame front for red oak flooring passes out the end of the tunnel in five minutes, thirty seconds (plus or minus 15 seconds).

For the ASTM E84-10 test standard, the flame spread classification is equal to 4900/(195−A_{T}), where A_{T} is the total area beneath the flame spread curve if the area is greater than 97.5 minute feet. If the area beneath the curve is less than or equal to 97.5 minute feet the classification becomes 0.515×A_{T}.

The Smoke Development Test uses a photocell to measure the amount of light that is obscured by the smoke passing down the tunnel duct. When the smoke from a burning sample obscures the light beam, the output from the photocell decreases. This decrease in time is recorded and compared to the results obtained for red oak, which is defined to be 100. The unrounded smoke developed index is equal to [(10,000−SmokeIntegration)/743]×100.

TABLE 4
Surface Burning Characteristics of Treated Samples and Reference
Products

| | | Flame | | Smoke |
|---|---|---|---|---|
| | Flame | Spread | Smoke | Developed |
| Sample Material | Spread | Classification | Developed | Classification |
| Treated Plywood | 36 | 35 | 101 | 100 |
| Treated Spruce | 18 | 20 | 113 | 115 |
| Lumber | | | | |
| Red Oak | | 100 | | 100 |
| (untreated) | | | | |
| Spruce | | 100 | | 100 |
| (untreated) | | | | |

In accordance with ASTM E84-10, the flame spread value is the raw measured value, flame spread classification is the raw value rounded to the nearest 5 and smoke development classification is the raw smoke development value rounded to the nearest 5 if less than 200. As shown from the foregoing table, the treated lumber samples had a substantially lower flame spread classification than comparable wood products including the red oak and spruce standards. The products had a similar smoke development classification.

By way of background, a maximum smoke-developed index of 450 is often used in building code regulations in the United States. The smoke development classification of the treated lumber and plywood were well below this limit. Furthermore, the United States building code groups flame spread into five classes, as shown in Table 5.

TABLE 5
Flame Spread Classification

| Class | Flame Spread Classification |
|---|---|
| A | 0-25 |
| B | 26-75 |
| C | 76-200 |
| D | 201-500 |
| E | Over 500 |

As shown by the foregoing, the treated plywood would receive a B rating in the United States for flame resistance, while the treated spruce would receive an A rating.

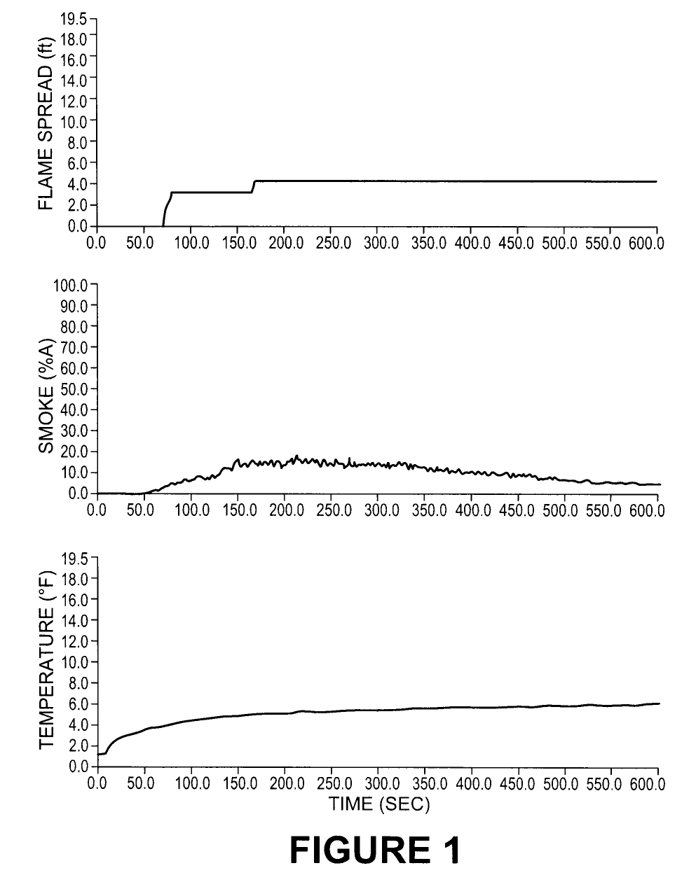

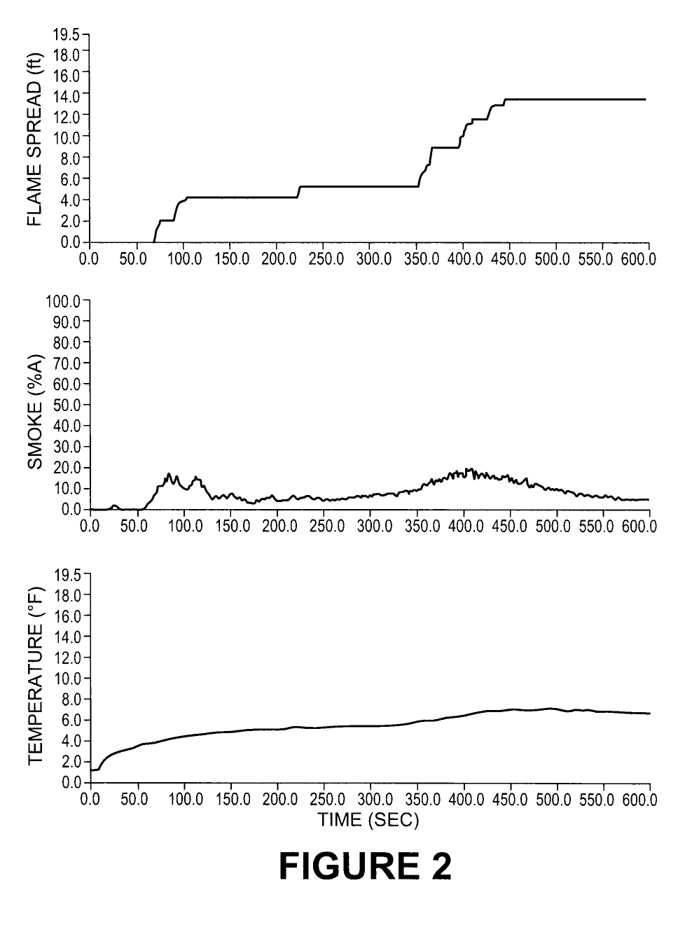

FIGS. 1 and 2 show the flame spread, smoke development and temperature data vs. time for the treated spruce and plywood samples, respectively, in accordance with ASTM E84-10.

### CAN-ULC S102-07 Testing

The surface burning characteristics of lumber and plywood samples coated with the composition as shown in Table 2 were also tested in accordance with the Canadian standard methods of CAN/ULC S102-7, specifically the Method of Test for Surface Burning Characteristics of Building Materials and Assemblies. The tests were conducted at the Intertek Evaluation Center in Coquitlam, British Columbia, Canada.

For the first test, samples of ⅝ inch thick plywood coated with the composition shown in Table 2 were placed in a conditioning room at a temperature of 23±3° C. (73.4±5° F.) and relative humidity of 50±5%. For each trial run, three 8 foot long by 24 inch wide sample panels of coated plywood were butted together and placed on the upper ledge of a flame spread tunnel to form a 24 foot sample length. A layer of 6 mm reinforced cement board was placed over top of the samples, the tunnel lid was lowered into place, and the samples were tested in accordance with CAN/ULC S102-07.

For the second test, the procedure was repeated using four 12 foot long by 12 inch wide treated spruce panels to form a 24 inch wide by 24 foot long sample length.

Similar to the ASTM E84-10 test, the CAN/ULC S102-07 test expresses the results as a flame spread classification index and a smoke developed index. The tests are conducted in the same manner as the ASTM E84-10 tests, as described above, however the calculations are performed differently. According to the CAN/ULC S102-07 test standard, the flame spread classification is equal to 5363/(195−A_{T}), and the unrounded smoke developed index is equal to [(10,000−SmokeIntegration)/1076]×100.

TABLE 6
Surface Burning Characteristics of Treated Samples in
accordance with CAN/ULC S102-07 and Reference Products

| | | Flame | | Smoke |
|---|---|---|---|---|
| | Flame | Spread | Smoke | Developed |
| Sample | Spread | Classification | Developed | Classification |
| ⅝″ Treated | | | | |
| Plywood | | | | |
| Run 1 | 33 | 40 | 62 | 60 |
| Run 2 | 46 | | 78 | |
| Run 3 | 43 | | 41 | |
| Treated Spruce | | | | |
| Lumber | | | | |
| Run 1 | 27 | 30 | 43 | 45 |
| Run 2 | 30 | | 41 | |
| Run 3 | 31 | | 50 | |
| Lumber, | | 150 | | 300 |
| untreated & | | | | |
| unfinished | | | | |
| Plywood, | | 150 | | 100 |
| untreated & | | | | |
| unfinished | | | | |
| (Douglas Fir, | | | | |
| Poplar, and | | | | |
| Spruce face | | | | |
| veneer) | | | | |

In accordance with CAN/ULC S102-07, the flame spread and smoke developed classifications are rounded to the nearest 5. During the tests, the treated plywood surfaces ignited at approximately 34 to 44 seconds and the treated spruce lumber surfaces ignited at approximately 33 to 44 seconds. For both the treated plywood and the treated spruce lumber, the flame began to progress along the samples until it reached the maximum flame spread. As shown from the foregoing table, the treated lumber and plywood samples had substantially lower flame spread and smoke developed classifications than comparable untreated and unfinished wood products.

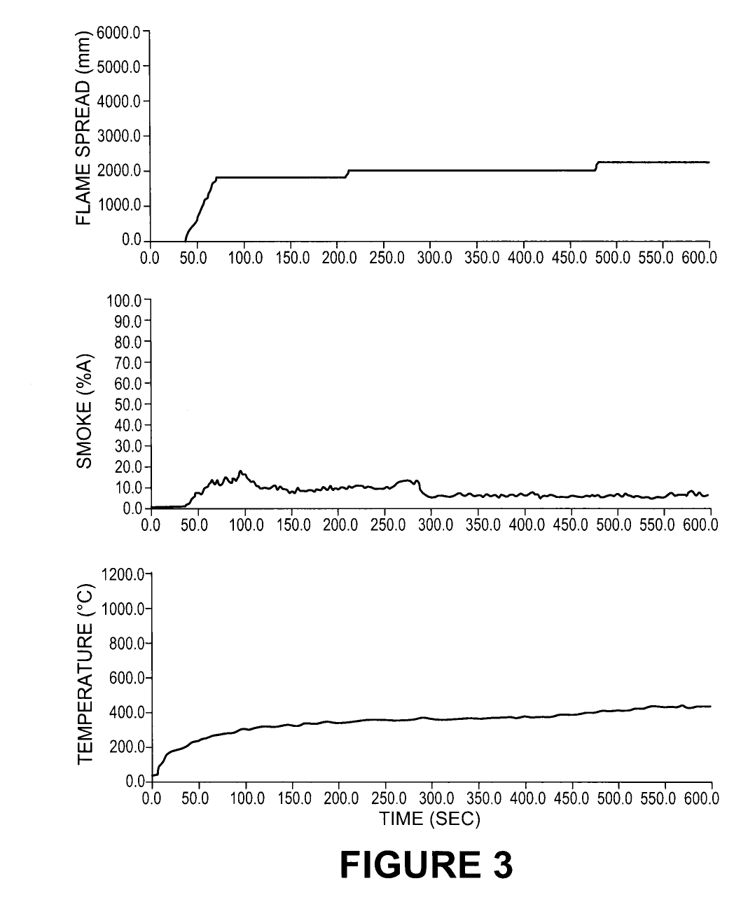

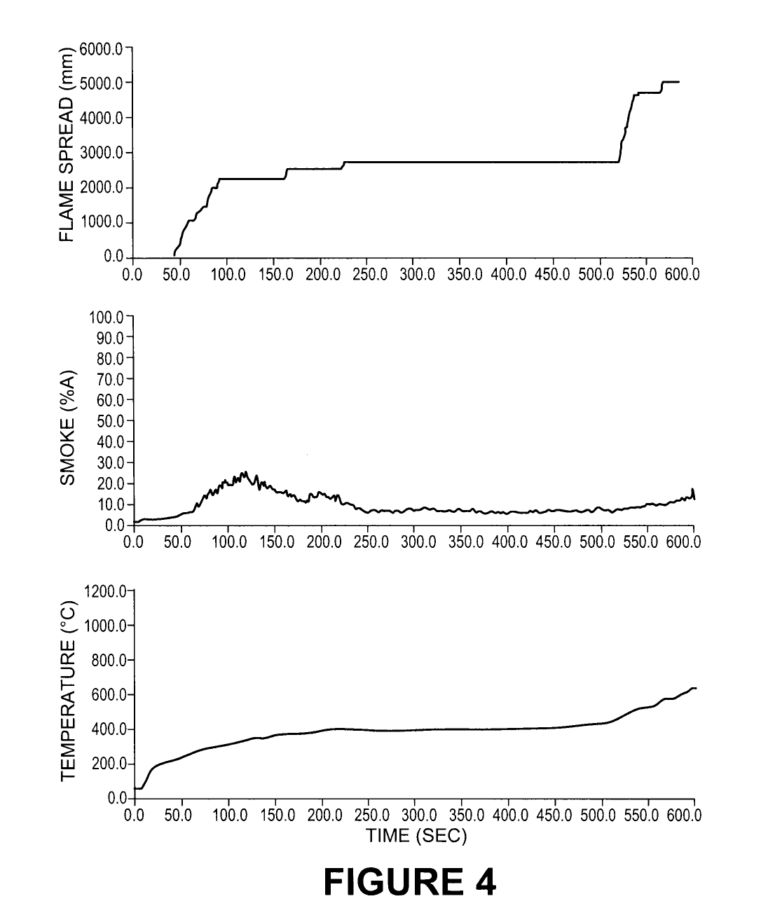

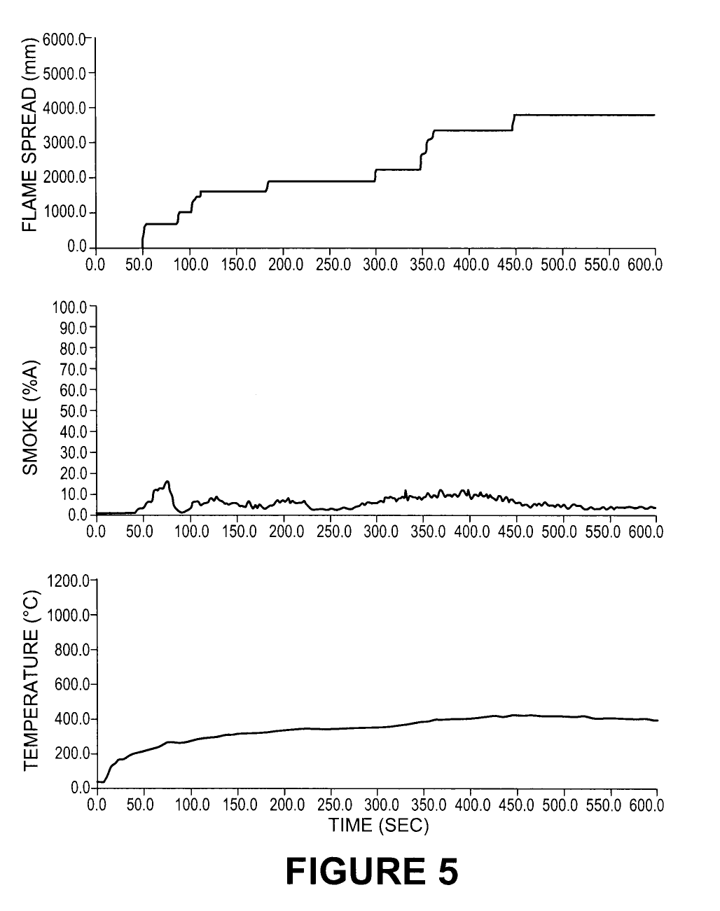

FIGS. 3, 4 and 5 illustrate the flame spread curve, smoke development and temperature data vs. time for the treated ⅝″ thick plywood samples for the three sample runs tested in accordance with CAN/ULC S102-07.

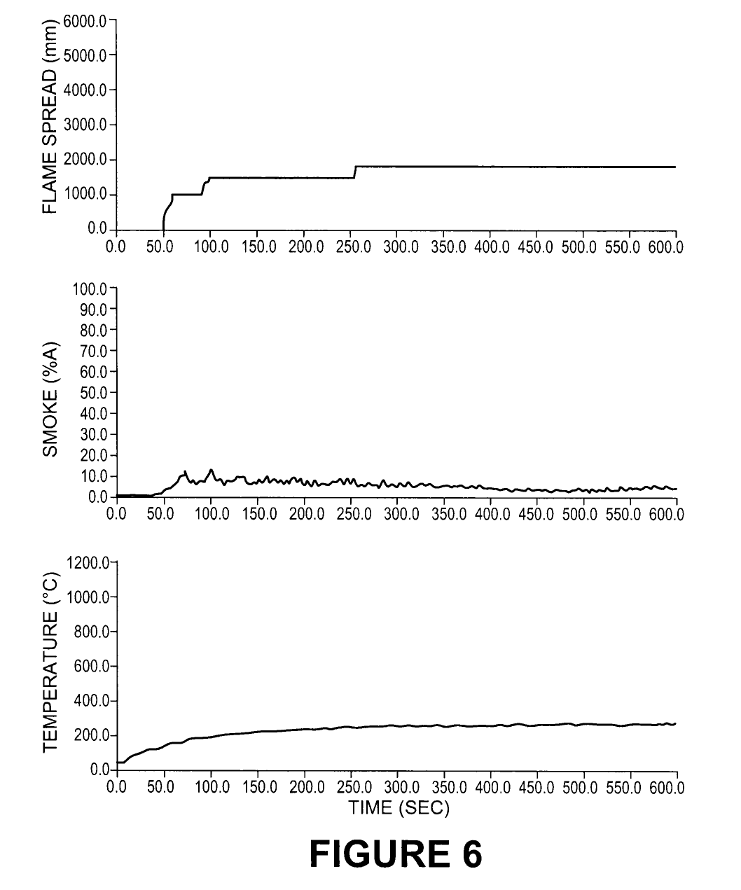

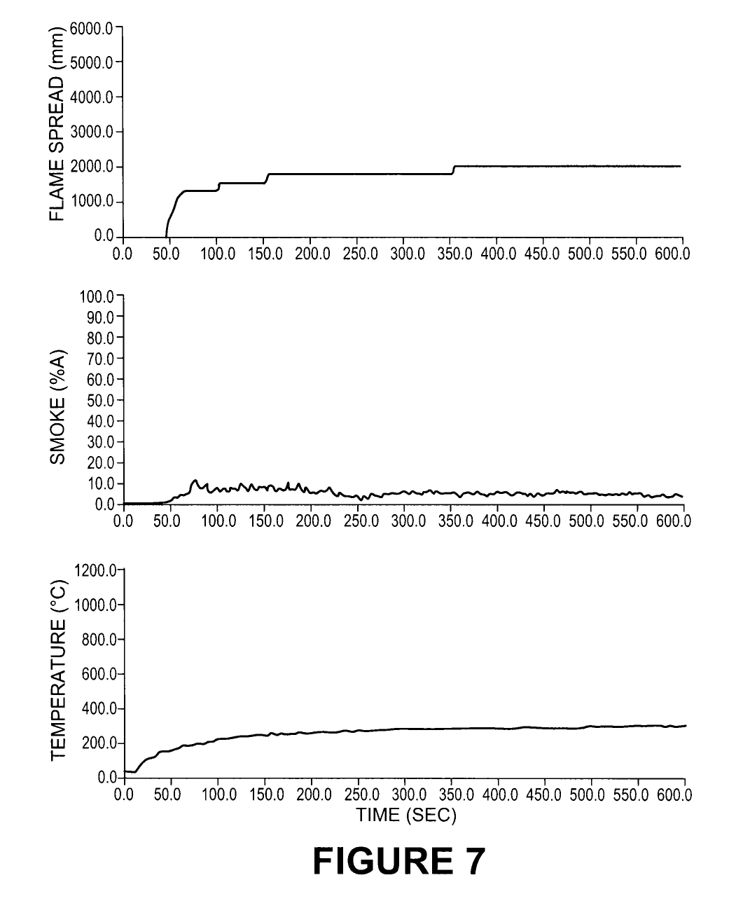

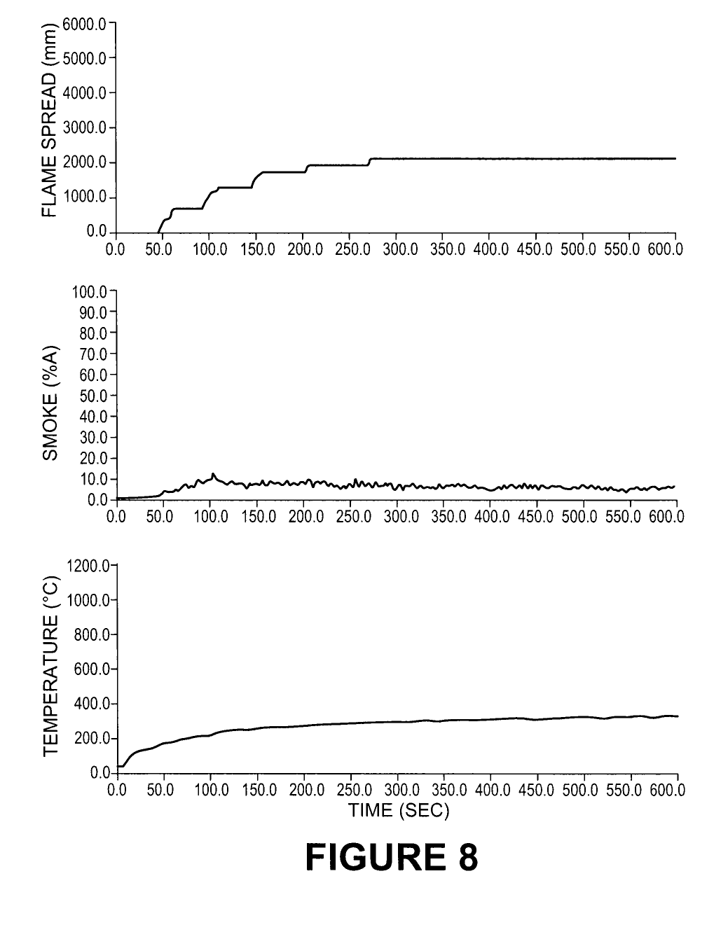

FIGS. 6, 7 and 8 illustrate the flame spread curve, smoke development and temperature data vs. time for the treated spruce lumber samples for the three sample runs tested in accordance with CAN/ULC S102-07.

Although the present invention has been described and illustrated with respect to preferred embodiments and preferred uses thereof, it is not to be so limited since modifications and changes can be made therein which are within the full, intended scope of the invention as understood by those skilled in the art.

1. A fire-resistant composition for application to a wood substrate comprising:
65-85 wt % water;
3-18 wt % acrylic resin;
3-7 wt % aluminum trihydrate; and
3-7 wt % ammonium polyphosphate.

2. The fire-resistant composition as in claim 1 further comprising up to 7 wt % of any one of or a combination of antisettling agents, defoamers, biocides, solvents, thickeners, surfactants, dispersants and clays.

3. The fire-resistant composition as in claim 2 further comprising less than 4 wt % anti-microbial agent.

4. The fire-resistant composition as in claim 1 further comprising at least one coloring agent.

5. The fire-resistant composition as in claim 4 wherein the at least one coloring agent is a pink coloring agent in a sufficient concentration to impart a pink coloration to a wood substrate treated with the composition.

6. The fire-resistant composition as in claim 1 wherein the concentration of alumina trihydrate and ammonium polyphosphate is sufficient to impart fire-resistant properties to a wood substrate treated with the composition.

7. The fire-resistant composition as in claim 6 wherein the fire-resistant properties have a Class B or better flame spread classification in accordance with ASTM E84-10.

8. A fire-resistant composition for application to a wood substrate comprising:
75.8 wt % water;
7.8 wt % acrylic resin;
4.7 wt % aluminum trihydrate;
4.7 wt % ammonium polyphosphate;
2.8 wt % anti-settling agent;
1.6 wt % anti-microbial agent;
1.2 wt % thickener;
1.1 wt % white colorant;
<0.1 wt % red colorant;
<0.1 wt % defoamer;
<0.1 wt % biocide;
<0.1 wt % solvent; and
<0.1 wt % surfactant.

9. The fire-resistant composition as in claim 3 further comprising:
at least one coloring agent, wherein the at least one coloring agent is a pink coloring agent in a sufficient concentration to impart a pink coloration to a wood substrate treated with the composition; and
wherein the concentration of alumina trihydrate and ammonium polyphosphate is sufficient to impart fire-resistant properties to a wood substrate treated with the compositions, wherein the fire-resistant properties have a Class B or better flame spread classification in accordance with ASTM E84-10.

10. A method of treating a wood substrate to impart fire-resistance to the wood substrate comprising the steps of:
a) coating a fire-resistant composition as in claim 1 on a lumber substrate; and
b) allowing the lumber substrate to dry.

11. A method as in claim 10 wherein the coating step is any one or a combination of spray, dip or brush coating.

12. A method of treating a wood substrate to impart fire-resistance to the wood substrate comprising the steps of:
a) coating a fire-resistant composition as in claim 3 on a lumber substrate; and
b) allowing the lumber substrate to dry.

13. A method of preparing a fire-resistant composition for treating a wood substrate comprising the steps of:
a) mixing an anti-settling agent with water to form a uniform mixture;
b) mixing acrylic resin, aluminum trihydrate, and ammonium polyphosphate with the uniform mixture from step a) to form a second uniform mixture;
wherein the final concentrations in the second uniform mixture are:
65-85 wt % water;
3-18 wt % acrylic resin;
3-7 wt % aluminum trihydrate;
3-7 wt % ammonium polyphosphate; and
<2.8 wt % anti-settling agent.

14. The method as in claim 13 further comprising adding an anti-microbial agent to the second uniform mixture in step b), wherein the final concentration of fungicide in the second uniform mixture is <4 wt %.
